(19) United States
(12) Patent Application Publication
(10) Pub. No.: US 2020/0012392 A1
(43) Pub. Date: Jan. 9, 2020

(54) DECISION-ORIENTED HEXAGONAL ARRAY GRAPHIC USER INTERFACE

(71) Applicant: SynaBEE, Inc., Wellington, FL (US)

(72) Inventors: Noel J. GUILLAMA, Wellington, FL (US); Chester A. HEATH, Boca Raton, FL (US); Jahziel M. GUILLAMA, Wellington, FL (US); Carl L. LARSEN, West Palm Beach, FL (US)

(21) Appl. No.: 16/552,820

(22) Filed: Aug. 27, 2019

Related U.S. Application Data
(63) Continuation-in-part of application No. 14/434,977, filed on Apr. 10, 2015, now Pat. No. 10,416,839.
(60) Provisional application No. 61/711,895, filed on Oct. 10, 2012.

(51) Int. Cl. G06F 3/0482; G06F 3/0481; G06F 3/0488

(52) U.S. Cl. CPC G06F 3/0482; G06F 3/04883; G06F 3/04817

(57) ABSTRACT

A system is provided, which includes a data repository, a processor and a terminal device. The data repository includes electronic databases. The processor is communicatively coupled to the electronic databases over a network. The terminal device is communicatively coupled to the processor. The terminal device includes a user interface with primary hexagon icons arranged in a hextille orientation in a first layer and secondary hexagon icons arranged in a hextille orientation in a second layer. The processor is configured to process user input received at the terminal device to detect a swipe selection across a first primary icon. The processor is also configured to send instructions to the terminal device to display the primary icon of the first layer and a secondary icon, positioned beneath the primary icon. The primary icon and the secondary icon are determined based on data from the electronic databases.

### CROSS-REFERENCE TO RELATED APPLICATIONS

This application claims priority to and the benefit of U.S. patent application Ser. No. 14/434,977, entitled “DECISION-ORIENTED HEXAGONAL ARRAY GRAPHIC USER INTERFACE” and filed Apr. 10, 2015, the contents of which are herein incorporated by reference in their entirety.

Both this application and U.S. patent application Ser. No. 14/434,977 claim priority to and the benefit of U.S. Provisional Application No. 61/711,895, entitled “HEX GUI” and filed Oct. 10, 2012, the contents of which are herein incorporated by reference in their entirety.

### FIELD OF THE INVENTION

The present invention relates to graphical user interface, and more specifically to a decision-oriented graphical user interface utilizing hexagonal tiles.

### BACKGROUND

Graphic User Interfaces have been defined typically as rectangular arrays of individually selectable icons, but there are a few with hexagonal icons, that can be packed tightly on a screen as in a beehive. Hexagons can also be found as isolated icons, organized into arrays where sides align. There are similar to strategy board games, like Chinese checkers, that have existed for millennia, the array of hexagons, or elements on a hexagonal field are used to define pathways to a goal for contestants to follow.

Smartphones and tablets have traditionally been used for connectivity and digital storage. With the advent of tracking cookies and other tracking technologies, it is not common for such devices to collect and integrate information and now assists in making decisions. Indeed, in the case routing of a trip using a map application of a global positioning system (GPS) device, a sequence of automated decisions is made in such devices to suggest a preferred path. This is the beginning of a trend to where the personal intelligent devices becomes an indispensable partner and advisor in most human decisions, the configuration of the graphic user interface of such personal intelligent devices will have a significant impact.

### SUMMARY

An exemplary system is provided. An exemplary corresponding method is also provided herein. The system includes a data repository, a processor, and a terminal device. The data repository includes electronic databases. The processor is communicatively coupled to each of the electronic databases within the data repository over a network. The terminal device is communicatively coupled to the processor. The terminal device includes a user interface with two or more primary hexagon icons arranged in a hextille orientation in a first layer and two or more secondary hexagon icons arranged in a hextille orientation in a second layer. The processor is configured to process user input received at the terminal device to detect a swipe selection across a first icon from the one or more primary icons. The processor is also configured to send instructions to the terminal device to display at least one icon of the primary hexagon icons of the first layer and a second icon positioned beneath the first icon in the primary layer. The first icon and the second icon are determined based on data received from the plurality of electronic databases.

In some examples, the processor is further configured to process user input received at the terminal device to detect a dig selection across a third icon from the one or more primary icons. The processor then sends instructions to the terminal device to display at least one of the secondary hexagon icons of the second layer including a fourth icon positioned beneath the third icon in the primary layer. The third icon and the fourth icon are determined based on data received from the plurality of electronic databases.

In some examples, the processor is also configured to process user input received at the terminal device to detect a stack selection at a fifth icon from the one or more primary icons. The processor then sends instructions to the terminal device to display a sixth icon in the secondary layer positioned beneath the fifth icon in the primary layer, and at least one subsequent icon positioned beneath the sixth icon in a tertiary layer. The fifth icon, the sixth icon, and the at least one subsequent icon are determined based on data received from the plurality of electronic databases.

The processor is further configured to process user input received at the terminal device to detect a smear selection at the fifth icon from the one or more primary icons. The processor is also configured to send instructions to the terminal device to display, at the user interface, the fifth icon, the sixth icon, and the at least one subsequent icon in a single layer. The fifth icon, the sixth icon, and the at least one subsequent icon are determined based on data received from the plurality of electronic databases.

The electronic databases can include electronic healthcare record databases, electronic law record databases, electronic educational record databases, electronic social media record databases, electronic financial record databases, and/or electronic governmental record databases. This is discussed in greater detail below.

An exemplary terminal device is provided. An exemplary corresponding method is also provided herein. The terminal device can include a display configured to receive user input, and a processor communicatively coupled to the display. The processor is configured to send instructions to the display to provide a user interface with two or more primary hexagon icons oriented in a hextille arrangement in a first layer and two or more secondary hexagon icons oriented in a hextille arrangement in a second layer. The processor is also configured to process user input received at the user interface to detect a swipe selection across a first icon from the one or more primary icons. The processor is further configured to send instructions to the display to provide at least one of the primary hexagon icons of the first layer and a second icon positioned beneath the first icon in the primary layer. Wherein the first icon and the second icon are determined based on data received from a plurality of electronic databases communicatively coupled to the processor.

In some examples, the processor is further configured to process user input received at the terminal device to detect a dig selection across a third icon from the one or more primary icons. The processor then sends instructions to the terminal device to display at least one of the secondary hexagon icons of the second layer including a fourth icon positioned beneath the third icon in the primary layer. The third icon and the fourth icon are determined based on data received from the plurality of electronic databases.

In some examples, the processor is also configured to process user input received at the terminal device to detect a stack selection at a fifth icon from the one or more primary icons. The processor then sends instructions to the terminal device to display a sixth icon in the secondary layer positioned beneath the fifth icon in the primary layer, and at least one subsequent icon positioned beneath the sixth icon in a tertiary layer. The fifth icon, the sixth icon, and the at least one subsequent icon are determined based on data received from the plurality of electronic databases.

The processor is further configured to process user input received at the terminal device to detect a smear selection at the fifth icon from the one or more primary icons. The processor is also configured to send instructions to the terminal device to display, at the user interface, the fifth icon, the sixth icon, and the at least one subsequent icon in a single layer. The fifth icon, the sixth icon, and the at least one subsequent icon are determined based on data received from the plurality of electronic databases.

Additional features and advantages of the disclosure will be set forth in the description that follows, and in part, will be obvious from the description; or can be learned by practice of the principles disclosed herein. The features and advantages of the disclosure can be realized and obtained by means of the instruments and combinations particularly pointed out in the appended claims. These and other features of the disclosure will become fully apparent from the following description and appended claims, or can be learned by the practice of the principles set forth herein.

### BRIEF DESCRIPTION OF THE DRAWINGS

In order to describe the manner in which the above-recited disclosure and its advantages and features can be obtained, a more particular description of the principles described above will be rendered by reference to specific examples illustrated in the appended drawings. These drawings depict only example aspects of the disclosure, and are therefore not to be considered as limiting of its scope. These principles are described and explained with additional specificity and detail through the use of the following drawings.

FIG. 1 illustrates an exemplary system, in accordance with the various embodiments disclosed herein;

FIG. 2 illustrates an alternative exemplary system, in accordance with the various embodiments disclosed herein;

FIG. 3 illustrates a user interface on a terminal device, in accordance with the various embodiments disclosed herein;

FIG. 4 illustrates exemplary hand gestures of a user for specific user input, in accordance with the various embodiments disclosed herein;

FIG. 5 illustrates exemplary primary icons in a first layer and exemplary secondary icons in a second layer, in accordance with the various embodiments disclosed herein;

FIG. 6 illustrates exemplary layers each with hexagon icons oriented in a hextille arrangement, in accordance with the various embodiments disclosed herein;

FIG. 7 illustrates an exemplary user input, in accordance with the various embodiments disclosed herein;

FIG. 8 illustrates an exemplary user input, in accordance with the various embodiments disclosed herein;

FIG. 9 illustrates an exemplary user input, in accordance with the various embodiments disclosed herein;

FIG. 10 illustrates an exemplary user input, in accordance with the various embodiments disclosed herein;

FIG. 11 illustrates a processor's ability to discern the exemplary user input, in accordance with the various embodiments disclosed herein; and

FIG. 12 illustrates a processor's ability to discern the exemplary user input, in accordance with the various embodiments disclosed herein.

### DETAILED DESCRIPTION

The present invention is described with reference to the attached figures, where like reference numerals are used throughout the figures to designate similar or equivalent elements. The figures are not drawn to scale, and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details, or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

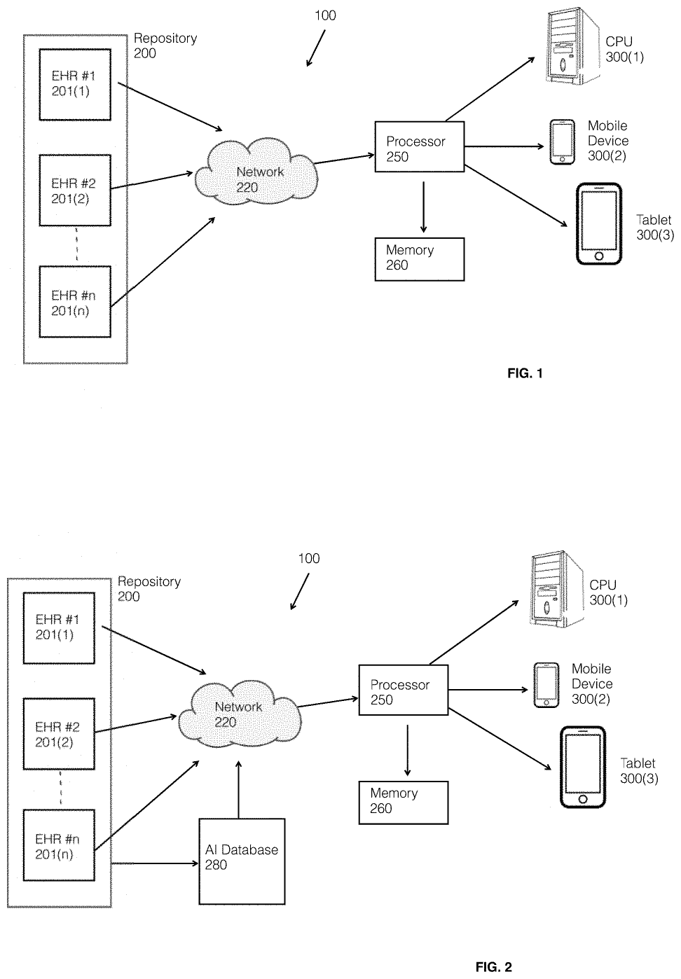

FIG. 1 illustrates an exemplary system 100, in accordance with the various embodiments disclosed herein. The system 100 can include an electronic repository 200. The electronic repository 200 can include multiple electronic healthcare records databases 201(1) . . . (n). The multiple electronic healthcare records databases 201(1) . . . (n) can be located across varying locations. While three multiple electronic healthcare records databases 201(1), 201(2) and 201(n) are illustrated herein, it should be understood that any number of electronic healthcare record databases can be implemented herein.

The databases within the electronic repository 200 are connected to a network 220. The network can include a local area network, or a wide area network. The system 100 also includes a processor 250 communicatively coupled to the network 220. The processor 250 can be communicatively coupled to a memory 260. The processor 250 can be communicatively coupled to a terminal device. In some examples, the terminal device can include a CPU 300(1), a mobile device 300(2), or a tablet device 300(3). Any other terminal device can be implemented herein. It should be understood that the terminal device need only provide a user interface to a user. While the processor 250 is illustrated to be separate from the terminal device, it should be understood that the processor can be located on the terminal device.

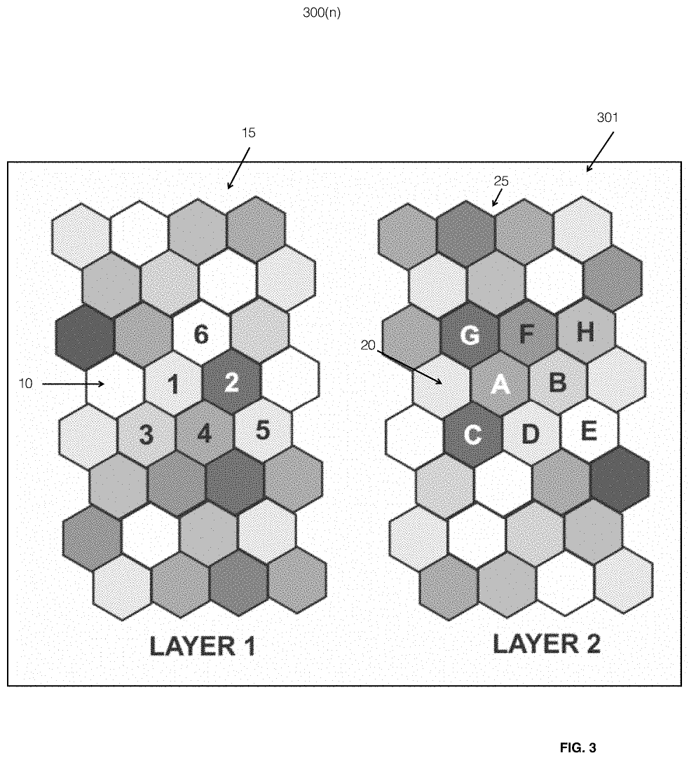

In some embodiments, the exemplary system 100 can be implemented for interpreting health-relevant data from multiple sources and utilizing the integration to develop decisions, diagnosis, care plans and health records of an individual's wellness, illnesses, or overall state of health. One of many embodiments is the concept is to arrive at a diagnosis and careplan with a compact vertical record, or Medikon, that includes all previous records, potentially including genetic history and externally created components, such as Artificial Intelligence analysis of that history. The terminal device provides a user interface that provides a vertical axis of a record. For example, the user interface provides a user access layers of a decision process, analogous to layers in a 3-dimensional data array, along a z-access. This is described in further detail with respect to FIG. 3.

FIG. 2 illustrates an alternative exemplary system 100, in accordance with the various embodiments disclosed herein. The system 100 can provide previous patient histories, previous diagnosis, care plans expressed as a decision process and genetic information and analysis and express all of this data as layers of a three-dimensional hexagonal array. A physician, reviewing a patient record, may wish to explore the stored decision process of previous caregivers, by swiping and digging down layer by layer from the outside, using simple hand movements on a pressure sensitive screen of the terminal device 300(1 . . . n). The alternative system 100 of FIG. 2 further includes a memory 260. The memory 260 can store previous decision paths and outcomes.

For example, a patient may have a chronic disease that has historically been diagnosed and treated. Prior to a physician proceeding through a new decision process, the physician may wish to review prior decisions and outcomes. The terminal device can display these prior decision paths and outcomes to the user via the user interface. The physician/user located at the terminal device can examine trends in diagnosis or treatment and extract a Z-axis core, relating to patient or disease history. The user can even examine relevant analytically reduced genetic information as part of their base line. Examples might be typel diabetes, heart disease, skeletal deformities, even chronic psychological disease. All of these may have a root in genetic makeup, that can be expressed through advancing medical science, potentially using Artificial Intelligence (AI). The alternative system 100 of FIG. 2 also includes an AI Database 280 configured to create a layer of tags for specific genetic expression throughout life. The physician/user located at the terminal device can elect to follow previous decision paths, or create a new one, on a new layer.

At specific enabled points in the three-dimensional array, the system 100 can enable extraction of a diagnosis history, care plans, meaningful use analysis of the care plans, and other relevant data—which can individually be extracted and presented as a timeline. Using this system 100, a physician/user at the terminal device is able to predict progress of the disease and identify any trends in diseases.

FIG. 3 illustrates a user interface 301 on a terminal device 300(n), in accordance with the various embodiments disclosed herein. The user interface 301 includes a first layer 15 of primary hexagon icons 10 arranged in a hextille orientation. The user interface 301 also includes a second layer 25 of secondary hexagon icons 20 arranged in a hextille orientation. It should be understood that the second layer 25 is beneath the first layer 14; therefore, the secondary hexagon icons 20 are generally not viewable in view of the first layer 14. A user is able to access the secondary hexagon icons 20 by providing a selection of input. These user inputs are discussed in greater detail below. The user interface 301 enables a user to penetrate the exterior 2-dimensional layer of a 3 dimensional “hive” by swiping aside hexagonal cells of a layer and digging down, layer by layer as required to reach a given particular, or specific level. The user may proceed along a decision process within an internal layer. Any layer may be closed or open to modification. In some examples, the extraction of a “core”, which might be a summary of historical information, can be provided. The core can be moved to another screen and “smeared” to depict the Z-axis information in a linear fashion. This is discussed in greater detail below.

The layers have different data in this example. The first layer 15 includes numeric data, whereas, the second layer 25 include alphabetic data. Each of the data characters represent data received from the electronic repository 200, of FIG. 1. The first layer 15 is superimposed over the second layer 25; thus, then only the first layer 15 is provided at the user interface 301 of the terminal device 300(n). While it may not be known if desirable data were hidden on a lower level, a feature to “peek” at data a layer below is useful prior to a decision to reveal the layer entirely. An operation named “Swipe” can temporarily reveal the layer below.

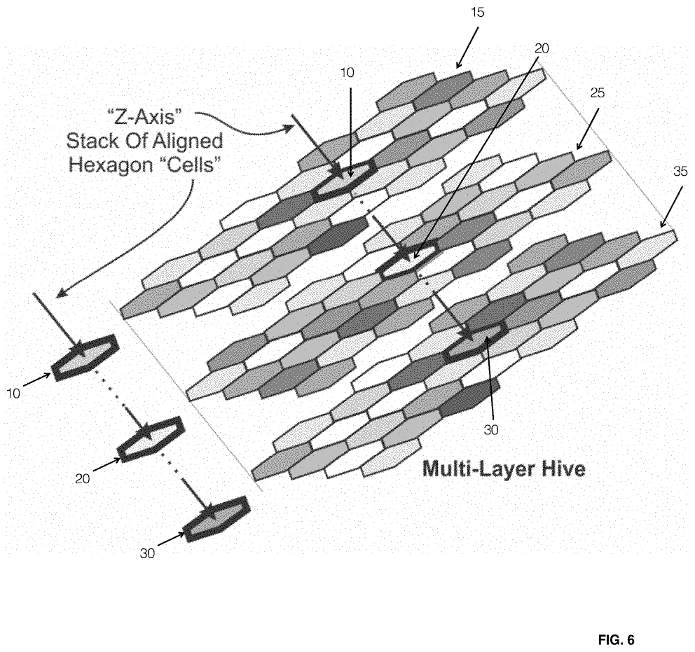

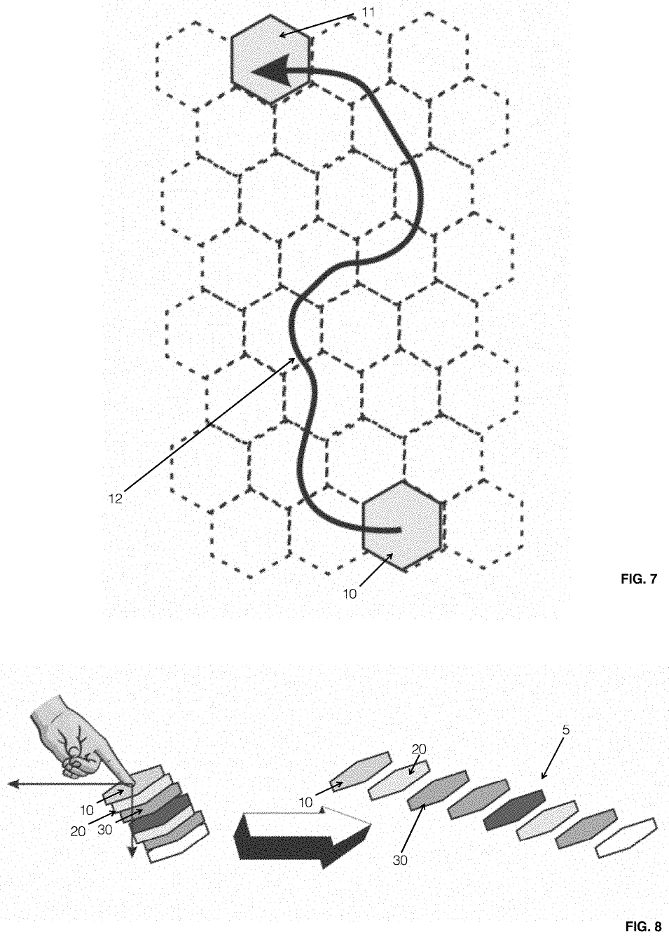

Referring momentarily to FIG. 7, which illustrates an exemplary user input 12, in accordance with the various embodiments disclosed herein. The exemplary user input 12 can include a two-dimensional Hexagonal Decision Oriented graphical user interface (GUI). In a two-dimensional Hexagonal Decision Oriented, the processor is able to detect user input with respect to a single hexagonal cell. The user input can specify a direction of entry or exit from the single hexagonal cell. The processor can provide responses to the user via the GUI based on rules of selection of opposing faces from the entry point of a cell. These would be essentially be 3-way choices, such as: “is the patient conscious, unconscious, or unresponsive” or is the patient's blood pressure low, high, or normal. In certain exceptions the hexagon would permit a 5-way decision tree, if exit is permitted by adjacent faces. The selections would be based on data received from the electronic repository 200 of FIG. 1.

For the purposes of illustration only, the system 100 of FIG. 1 can be implemented with healthcare data repository. It should be understood, however, that the system 100 can include many industrial applications, including, for example, legal, educational, social media, financial and governmental applications. With respect to the governmental applications, the system 100 can be implemented in specific scenarios in military, and homeland security applications. The present application provides the data from the decision oriented hexagonal array GUI in a layered format, such that related information may be presented and revealed by user input/human interaction in the provided interface. Additional layers may be simple previous decision processes, or they may be related information to a decision.

Referring back to FIG. 3, the layers have different data in this example. The first layer 15 includes numeric data, whereas, the second layer 25 include alphabetic data. Each of the data characters represent data received from the electronic repository 200, of FIG. 1. The first layer 15 is superimposed over the second layer 25; thus, then only the first layer 15 is provided at the user interface 301 of the terminal device 300(n). While it may not be known if desirable data were hidden on a lower level, a feature to “peek” at data a layer below is useful prior to a decision to reveal the layer entirely. An operation named “Swipe” can temporarily reveal the layer below.

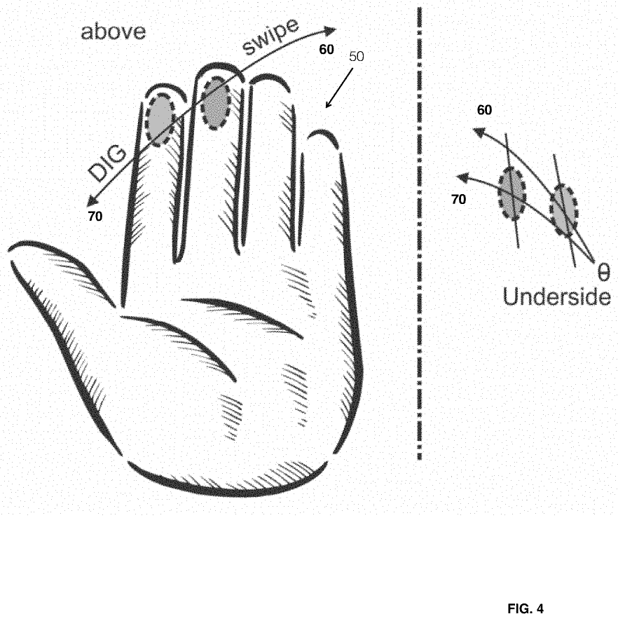

FIG. 4 illustrates exemplary hand gestures of a user for specific user input 12, in accordance with the various embodiments disclosed herein. The first hand gesture 60 that the processor is configured to receive and interpret is a swipe. The terminal device of FIG. 1, can include a touch sensitive screen configured to receive the user input. The touch sensitive screen is configured to detect the presence of two, or more fingers above hexagonal icons on a given layer. The processor, of FIG. 1, is configured to process the user input received at the terminal device to detect a swipe selection across a first icon from the one or more primary icons of the first layer. The processor is able to send instructions to the terminal device to display an icon of the primary hexagon icons of the first layer and a second icon positioned beneath the first icon in the primary layer. In this way, a user can swipe across the desired icons using his/her finger to reveal a corresponding secondary icon underneath. The user's fingertips slide above the screen as the pressure underneath is detected. Specific cells in the layer underneath are then selected and thereby “revealed”. The reveal operation can be repeated at multiple positions, and subsequent portions of the image become revealed. It should be understood the first icon and the corresponding second icon are determined based on data received from the plurality of electronic databases.

The second hand gesture 70 that the processor is configured to receive and interpret is a dig. The dig operation essentially removes the entire outer layer (in this case, the first layer 15) from view at the user interface. In recognizing the second hand gesture 70, the processor enables a user to quickly test and remove successive layers. The swipe and dig operations may involve visual image data or alphanumeric data. In one embodiment, each layer may be a page in a patient record that the physician flips through to get the specific information desired. The pages may include x-rays, visual test results like EKG, pictures of the individual and the like. The cells can also be assigned specific icons, representing links to expanded data anywhere in a database or the Internet.

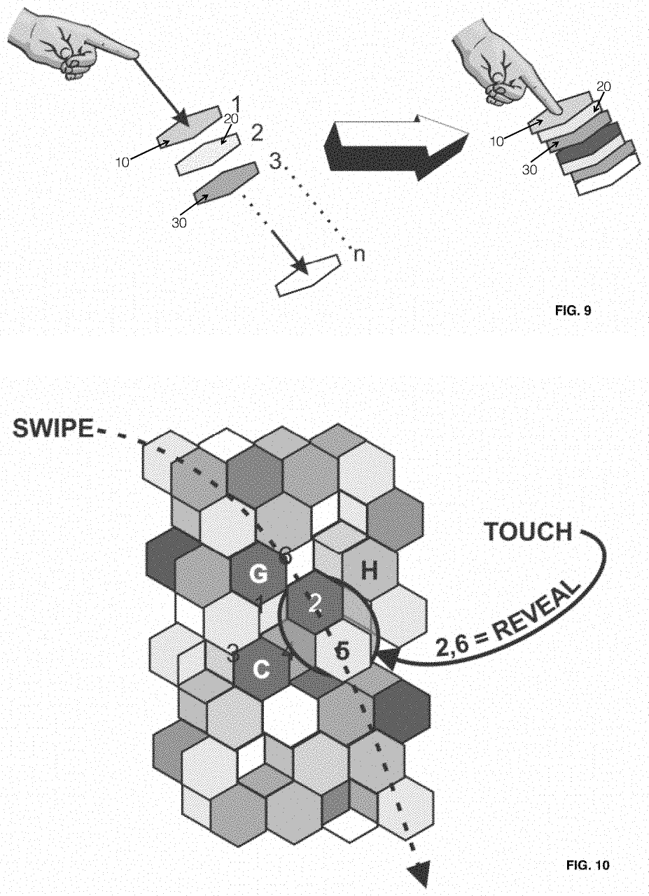

Referring momentarily to FIG. 10, which illustrates an exemplary user input, in accordance with the various embodiments disclosed herein. The terminal device provides the numerals of the first layer and the alphabetic characters of the second layer, where the fingers touch the screen in the swipe operation. The information shown in the hexagonal cells is not limited to single alphanumeric characters, but may also be icons, links, whole or portions of a visual image, or may expand to entire records if selected. Note that the figure shows revealing of data when the two layers are not aligned—although there are advantages to keeping the layers aligned for clarity.

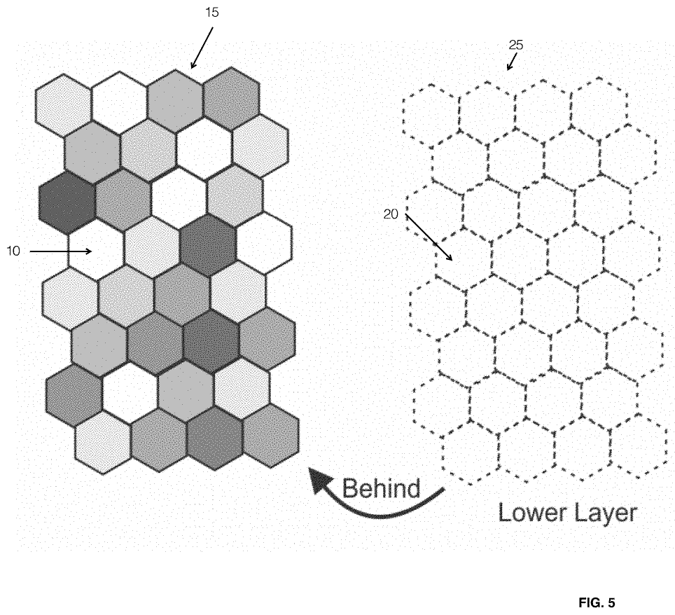

FIG. 5 illustrates exemplary primary icons 10 in a first layer 15 and exemplary secondary icons 20 in a second layer 25, in accordance with the various embodiments disclosed herein. The first layer 15 can be presented to the user at the user interface of the terminal device 300(1) of FIG. 1. The second layer 25 is positioned beneath the first layer 15. In this case, primary icons 10 can be shaped as a hexagon. The first layer 15 can include multiple icons 10 arranged in a hextille orientation. Similarly, the second layer 25 can include multiple icons 20 arranged in a hextille orientation.

FIG. 6 illustrates exemplary layers 15, 25, and 35; each layer with hexagon icons oriented in a hextille arrangement, in accordance with the various embodiments disclosed herein. The terminal device can display the data from the electronic repository 200, of FIG. 1, in multiple layers of information. For purposes of illustration, the user interface only provides three exemplary layers 15, 25 and 35. However, it should be understood that multiples of layers can be provided herein. In some exemplary embodiments, prior diagnosis (singular or plural) of the same individual, or disease, or managed by the same care-giver, process or pharmaceutical may be arranged per a hive of typically related data. This would be useful for “Meaningful Use” calculation, and optimal care decision selections. The aligned cells shown may be specific entry or exit points of the array where information is organized or available along a z-axis line and could be shown as highlighted, colored, or flashing on the screen. These vertically aligned stacks of hex cells might represent a patient history, disease history, trial results of a drug, end results of a diagnosis, test results or psychological evaluations. It is important to understand that even though key points along a decision path may align, the paths otherwise can be distinct. The common denominator is that the data is typically aligned and related and meaningful. It is desired to select these icons for potential transfer or analysis elsewhere. This introduces two new user-input-driven operations: “Stick” and “Smear”.

FIG. 8 illustrates an exemplary user input, a smear operation, in accordance with the various embodiments disclosed herein. A “Smear” operation will take the hexagon cell stack 5, which includes hexagonal icons 10, 20, and 30, from the first layer, the second layer and the third layer, respectively. The hexagon cell stack 5 may be illustratively “stuck” to the finger. Each of the hexagonal icons of the hexagon cell stack 5 is able to be viewed in spread out format for analysis or reports on a clear page or other point of data entry.

FIG. 9 illustrates an exemplary user input, a stick operation, in accordance with the various embodiments disclosed herein. The processor interprets a stick operation as a partial selection or a complete selection of all of the data sets aligned along a Z-axis. The user simply presses on the revealed cell and holds as the cells along an axis are catenated. The processor may instruct the terminal device to provide haptic feedback as each level along the Z-axis is attached. In some alternative examples, a simple hold that exceeds a predetermined threshold may catenate all the cells in the respective layers. If the reveled cell is on the outer layer, then potentially the entire stack of hexagonal cells can be selected—potentially forming a Medikon as defined in the listed related patent. Once they are catenated, a copy of the stack is logically “stuck” to the fingertip cursor. The cells may be then pasted into other places in the same array, or a different array, or “smeared” out linearly.

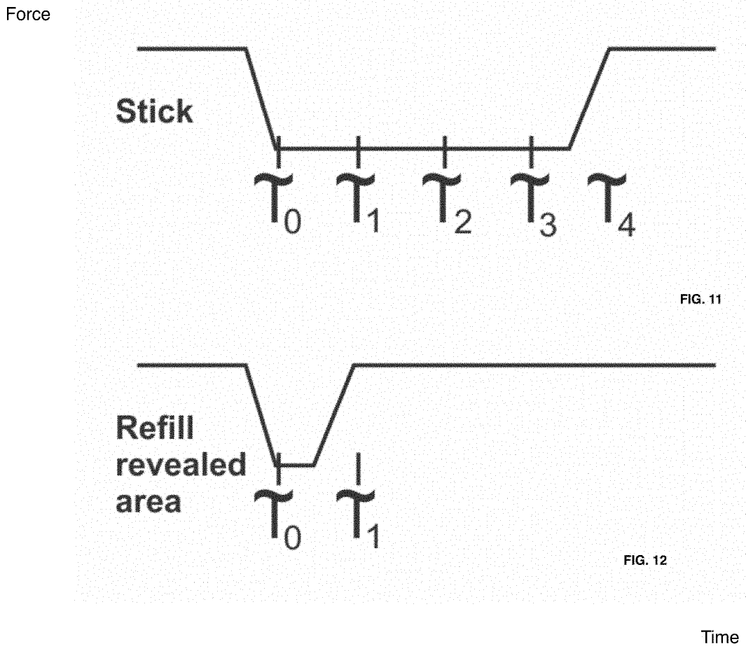

The stick and smear operations are easily discriminated by the processor. The stick operation persists for several time periods, each associated with a layer, or long enough that the entire stack is catenated and logically adhered to the fingertip. FIG. 11 illustrates a processor's ability to discern the stick operation, in accordance with the various embodiments disclosed herein. FIG. 12 illustrates a processor's ability to discern the smear operation, in accordance with the various embodiments disclosed herein. Similar “pop” replenishment operations on revealed potions of an array restore the presented image, layer by layer, with instantaneous pressure (<T) to refill a revealed layer with its previously stored data for that segment. Creating a full stack of information is thereby easily done by tapping on revealed layers repeatedly until the outer layer is reached and then pressing on that layer until the full stack is “stuck” to the fingertip cursor. This would allow a physician to easily prepare a report, say a current case history of a given patient's disease, along with links to relevant literature, for a common care team covering that patient. This would be both time prohibitive, and far too complex for human compilation absent the disclosed system 100.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A system comprising:
a data repository comprising a plurality of electronic databases;
a processor communicatively coupled to each of the electronic databases within the data repository over a network;
a terminal device communicatively coupled to the processor, wherein the terminal device comprises a user interface with two or more primary hexagon icons arranged in a hextille orientation in a first layer and two or more secondary hexagon icons arranged in a hextille orientation in a second layer,
wherein the process is configured to:
process user input received at the terminal device to detect a swipe selection across a first icon from the one or more primary icons; and
send instructions to the terminal device to display at least one icon of the primary hexagon icons of the first layer and a second icon positioned beneath the first icon in the primary layer, wherein the first icon and the second icon are determined based on data received from the plurality of electronic databases.

2. The system of claim 1, wherein the processor is further configured to:
process user input received at the terminal device to detect a dig selection across a third icon from the one or more primary icons; and
send instructions to the terminal device to display at least one of the secondary hexagon icons of the second layer including a fourth icon positioned beneath the third icon in the primary layer, wherein the third icon and the fourth icon are determined based on data received from the plurality of electronic databases.

3. The system of claim 1, wherein the processor is further configured to:
process user input received at the terminal device to detect a stack selection at a fifth icon from the one or more primary icons; and
send instructions to the terminal device to display a sixth icon in the secondary layer positioned beneath the fifth icon in the primary layer, and at least one subsequent icon positioned beneath the sixth icon in a tertiary layer, wherein the fifth icon, the sixth icon, and the at least one subsequent icon are determined based on data received from the plurality of electronic databases.

4. The system of claim 3, wherein the processor is further configured to:
process user input received at the terminal device to detect a smear selection at the fifth icon from the one or more primary icons;
send instructions to the terminal device to display, at the user interface, the fifth icon, the sixth icon, and the at least one subsequent icon in a single layer, wherein the fifth icon, the sixth icon, and the at least one subsequent icon are determined based on data received from the plurality of electronic databases.

5. The system of claim 1, wherein the plurality of electronic databases comprises a database selected from the group consisting of: electronic healthcare record databases, electronic law record databases, electronic educational record databases, electronic social media record databases, electronic financial record databases, and electronic governmental record databases.

6. A terminal device comprising:
a display configured to receive user input; and
a processor communicatively coupled to the display and configured to:
send instructions to the display to provide a user interface with two or more primary hexagon icons oriented in a hextille arrangement in a first layer and two or more secondary hexagon icons oriented in a hextille arrangement in a second layer;
process user input received at the user interface to detect a swipe selection across a first icon from the one or more primary icons;
send instructions to the display to provide at least one of the primary hexagon icons of the first layer and a second icon positioned beneath the first icon in the primary layer, wherein the first icon and the second icon are determined based on data received from a plurality of electronic databases communicatively coupled to the processor.

7. The terminal device of claim 6, wherein the processor is further configured to:
process user input received at the user interface to detect a dig selection across a third icon from the one or more primary icons; and
send instructions to display at least one of the secondary hexagon icons of the second layer including a fourth icon positioned beneath the third icon in the primary layer, wherein the third icon and the fourth icon are determined based on data received from the plurality of electronic databases.

8. The terminal device of claim 6, wherein the processor is further configured to:
process user input received at the user interface to detect a stack selection at a fifth icon from the one or more primary icons; and
send instructions to display a sixth icon in the secondary layer positioned beneath the fifth icon in the primary layer, and at least one subsequent icon positioned beneath the sixth icon in a tertiary layer, wherein the fifth icon, the sixth icon, and the at least one subsequent icon are determined based on data received from the plurality of electronic databases.

9. The terminal device of claim 8, wherein the processor is further configured to:
process user input received at the user interface to detect a smear selection at the fifth icon from the one or more primary icons;
send instructions to display, at the user interface, the fifth icon, the sixth icon, and the at least one subsequent icon in a single layer, wherein the fifth icon, the sixth icon, and the at least one subsequent icon are determined based on data received from the plurality of electronic databases.

10. The terminal device of claim 6, wherein the plurality of electronic databases comprises a database selected from the group consisting of: electronic healthcare record databases, electronic law record databases, electronic educational record databases, electronic social media record databases, electronic financial record databases, and electronic governmental record databases.

11. A method comprising:
sending instructions to a display to display a user interface with two or more primary hexagon icons oriented in a hextille arrangement in a first layer and two or more secondary hexagon icons oriented in a hextille arrangement in a second layer;
processing user input received at the user interface to detect a swipe selection across a first icon from the one or more primary icons;
sending instructions to display at least one of the primary hexagon icons of the first layer and a second icon positioned beneath the first icon in the primary layer, wherein the first icon and the second icon are determined based on data received from a plurality of electronic databases.

12. The method of claim 11, further comprising:
processing user input received at the user interface to detect a dig selection across a third icon from the one or more primary icons; and
sending instructions to display at least one of the secondary hexagon icons of the second layer including a fourth icon positioned beneath the third icon in the primary layer, wherein the third icon and the fourth icon are determined based on data received from the plurality of electronic databases.

13. The method of claim 11, further comprising:
processing user input received at the user interface to detect a stack selection at a fifth icon from the one or more primary icons; and
sending instructions to display a sixth icon in the secondary layer positioned beneath the fifth icon in the primary layer, and at least one subsequent icon positioned beneath the sixth icon in a tertiary layer, wherein the fifth icon, the sixth icon, and the at least one subsequent icon are determined based on data received from the plurality of electronic databases.

14. The method of claim 11, further comprising:
processing user input received at the user interface to detect a smear selection at the fifth icon from the one or more primary icons;
sending instructions to display, at the user interface, the fifth icon, the sixth icon, and the at least one subsequent icon in a single layer, wherein the fifth icon, the sixth icon, and the at least one subsequent icon are determined based on data received from the plurality of electronic databases.

15. The method of claim 11, wherein the plurality of electronic databases comprises a database selected from the group consisting of: electronic healthcare record databases, electronic law record databases, electronic educational record databases, electronic social media record databases, electronic financial record databases, and electronic governmental record databases.
